(19) United States
(12) Patent Application Publication
(10) Pub. No.: US 2007/0210128 A1
(43) Pub. Date: Sep. 13, 2007

(54) Gun case for use with boats

(76) Inventor: John V. Tilby, Sandy, UT (US)

Correspondence Address: John V. Tilby, 9352 South 670 West, Sandy, UT, 84070, US

(21) Appl. No.: 11/371,566

(22) Filed: Mar. 10, 2006

(51) Int. Cl. B60R 7/00; B60R 9/00

(52) U.S. Cl. 224/406; 224/913

(57) ABSTRACT

A long gun case for use in boats and having connectors for securement to the gunwale of a boat and open ended, suspended, gun receiving pouches, arranged with access openings at the ends of each pouch that are not obstructed by another suspended pouch and the gun receiving pouches constructed to allow water to drain therefrom and a facing that will protect guns inserted therein from view; and a weight receiving pouch at the bottom edge of the case to insure suspension of the gun case.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO MICROFICHE APPENDIX

Not Applicable.

### BACKGROUND OF THE INVENTION

1. Field of the Invention

This invention relates to bags for holding and protecting shotguns and other long guns during the transportation of the guns in boats.

Water fowl hunters and hunters of other game often will transport and use guns while in watercraft. Such transporting presents problems relating to safe transport of the guns, and protection of guns in a situation where the guns are subjected to water and where they can rust or otherwise be damaged by water collecting thereon.

It is also necessary that the long guns being transported by watercraft during hunting activities, must be easily, quickly and safely retrieved for use when a target is spotted.

Various kinds of hard and soft gun cases have been used by hunters to protect their guns when the guns are transported in watercrafts. Generally, the hard cases used are elongate and have hinges allowing a top to be pivotally opened to display a gun resting on a bottom portion of the case. Soft cases commonly used also frequently include top and bottom fabric portions hinged on one side and with a zipper to close and open an opposite side of the case as the gun is placed in the case for protection, or is removed for use. These well known cases are generally set on the floor, or possibly a seat, of the watercraft used. Since the cases must be unlocked or unzipped before a gun therein can be removed, retrieval of a stored gun cannot be performed quickly. Furthermore, as a long gun is removed from a case on the floor or seat of a boat, it is very easy to swing the gun and to point the barrel of the gun at persons in the boat.

There remains a need for a protective case for long guns that permits quick, easy retrieval of a gun stored therein with a reduced possibility that the gun barrel will be directed at a person in the boat.

### BRIEF SUMMARY OF THE INVENTION

Objects of the Invention

Principal objects of the invention are to provide a long gun case that is readily mounted in a boat and that will protect guns inserted into the case while accommodating quick, easy placement of the guns in the case and quick, easy removal of the guns for use.

Other objects are to provide a long gun case that is easily positioned for use in a boat and that is easily and compactly stored when not in use.

Still another object is to provide a long gun case that, when properly positioned in a boat, allows long guns to be placed in the case and removed from the case in a manner that minimizes the possibility of misfiring such that persons in the boat are injured.

Features of the Invention

Principal features of the long gun case of the invention include an elongate foldable fabric case with open ended suspended pouches to receive long guns.

The case includes connectors to be used in securing the case to be suspended from the gunwale of a boat. The pouches of the gun case include enlarged openings through which a long gun is inserted muzzle end first. The enlarged openings are spaced apart such that one pouch does not obstruct entry into another pouch.

The pouches hold long guns inserted therein alongside the boat gunwale and during insertion and removal of guns into and out of the pouches, the guns are always pointed parallel and close to the gunwale. Consequently, there is a greatly reduced chance that a user will point the gun towards another person in the boat during insertion and removal of the long gun into and out of the case.

The pouches of the gun case are each constructed to include a mesh portion to permit water drainage and to prevent damage to an inserted long gun, and a fabric facing sheet that will hide the long gun so that prospective thieves will not be able to observe a gun therein.

An open ended weight pocket is formed along a bottom of the suspended gun case. This pocket allows one or more weights to be inserted therein to hold the bag in a suspended condition, even when a long gun is not inserted into a pouch.

Pockets may be formed in the gun case to receive ammunition, maps, or other articles the user decides to place therein.

Additional objects and features of the invention will become apparent to persons skilled in the art to which the invention pertains from the following detailed description and claims.

### BRIEF DESCRIPTION OF THE SEVERAL VIEWS OF THE DRAWINGS

In the Drawings

FIG. 1 is a pictorial view of the gun case of the invention mounted to a starboard side gunwale of a boat, the boat being shown fragmentarily;

FIG. 2, a front elevation view of the gun case of the invention;

FIG. 3, a back plan view of the gun case of the invention;

FIG. 4, a fragmented front perspective view taken from one end of the gun case and showing the gun pouches raised;

FIG. 5, a vertical section taken on the line 5-5 of FIG. 2; and

FIG. 6, a similar view taken on the line 6-6 of FIG. 2.

### DETAILED DESCRIPTION OF THE INVENTION

Referring now the Drawings

In the illustrated preferred embodiment of the invention, the gun case is shown generally at 10.

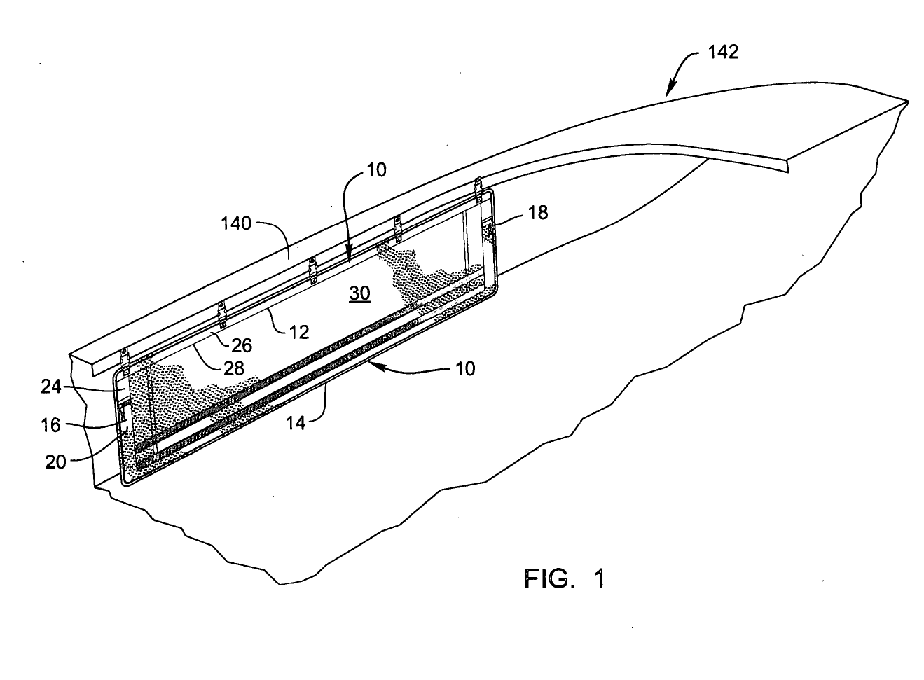

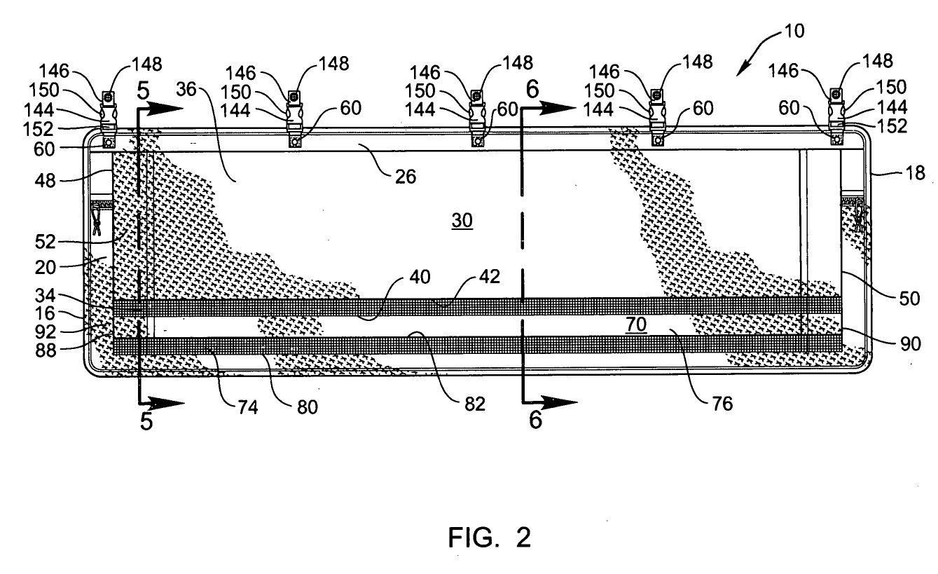

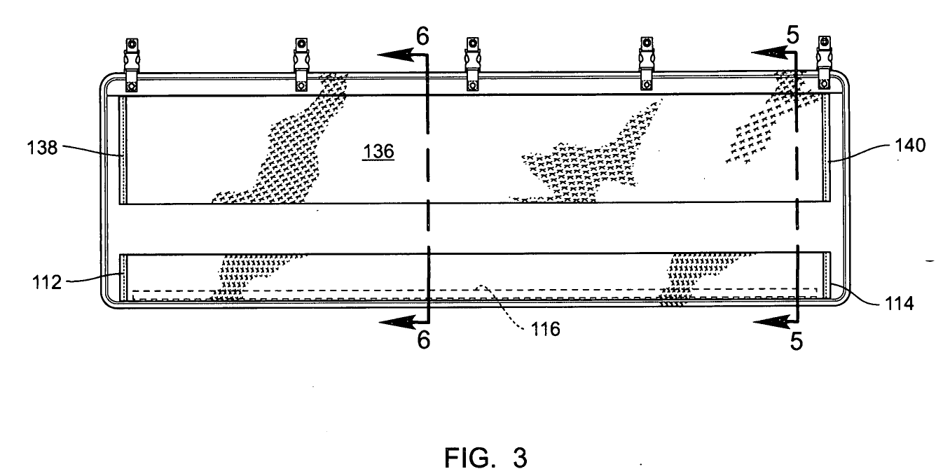

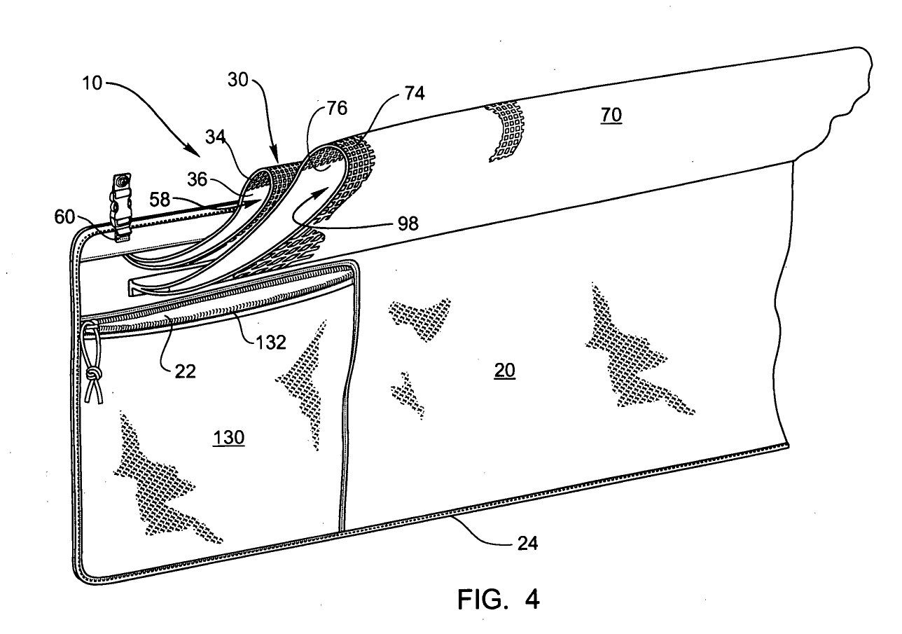

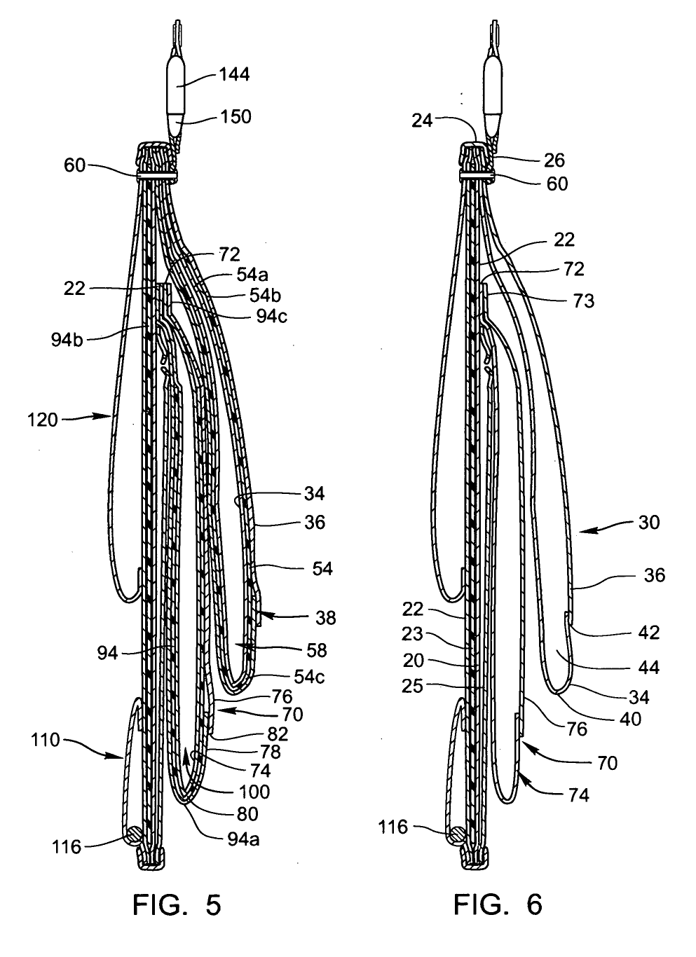

Gun case 10 includes a top edge 12 and a bottom edge 14 interconnected by spaced apart left and right ends 16 and 18, respectively, as viewed in FIGS. 1 and 2.

The top and bottom edges 12 and 14 and left and right ends 16 and 18, are interconnected by front and back fabric sheets 20 and 22. An edging strip 24 is folded over and extends around the fabric sheets and is sewn thereto to form a periphery of the bag. A soft flexible backing sheet 23 of plastic, or the like, is positioned between back fabric sheet 22 and another flexible sheet 25 between the sheet 22 and front fabric sheet 20.

A reinforcement strip 26 is also sewn between the edging 24 and the fabric sheets 20 and 22. Strip 26 is fully sewn in place, i.e., to the sheets 20 and 22 and over top edge 28 of a top pouch 30 that is suspended from beneath the reinforcement strap when the gun case 10 is in use, as will be further described.

Top pouch 30 comprises a mesh backing sheet 34 and a flexible fabric facing sheet 36. The mesh backing sheet 34 and fabric facing sheet 36 are both sewn beneath the reinforcement strip 26. The mesh backing sheet 34 extends downwardly (as viewed in FIGS. 1 and 2) from the reinforcement strip 26 and is turned back at 40 to be sewn to a bottom edge 42 of fabric facing sheet 36. An open long gun receiving space 44 is formed between the mesh backing sheet 34 and fabric facing sheet 36.

Mesh backing sheet 34 and fabric sheet 36 are turned inwardly back at each of the opposite ends 48 and 50 of top pouch 30 to form a sleeve 52. A flexible solid strip 54 of plastic, or the like, is positioned in the sleeve 52 with a center of the strip curved back at the bottom edge of the top pouch 30. The ends 54a and 54b of the strip 54 come together at the top edge of the top pouch 39, adjacent to reinforcement strip 26. The curved back central portion 54c of the plastic strip 54 holds the bottom portion of pouch 30 open to provide an access 58 to the interior of the pouch.

Grommeted holes 60 are spaced along the reinforcement strip 26 and are used in suspension of the gun case 10, as will be further explained.

A bottom pouch 70, preferably constructed to be the same as top pouch 30, has its top edge 72 sewn to the fabric facing sheet 22.

Like pouch 30, pouch 70 includes a mesh backing sheet 74 and a flexible fabric sheet 76 that are sewn together and to fabric facing sheet 22 to form the top edge 72 of pouch 70. The mesh backing sheet 74 extends downwardly (as viewed in FIGS. 1 and 2) from the top edge 72 and is turned back at 80 to be sewn to a bottom edge 82 of facing sheet 76.

Mesh backing sheet 74 and fabric facing sheet 76 are turned inwardly back at each of the opposite ends 88 and 90 of bottom pouch 70 to form a sleeve 92.

A flexible, solid strip 94 of plastic, or the like, is positioned in the sleeve 92 with a center 94a of the strip curved back at the bottom edge of the bottom pouch. The ends 94a and 94b of the strip 94 terminate at the top edge of the bottom pouch 70. The curved back portion 94c of plastic strip 94 holds the bottom portion of bottom pouch 70 open to provide an access 98 to the interior space 100 of the bottom pouch 70.

The bottom pouch 70 is positioned to be suspended from top edge 72 so that the access 98 of the bottom pouch 70 is positioned below the accesses 58 of top pouch 30. With the accesses 98 suspended lower than the accesses 58, the access openings of both pouches 30 and 70 are always open, unblocked, and available to receive the muzzle of a long gun as the gun is inserted into either pouch. With accesses at each end of each pouch, the guns are easily inserted muzzle first into a selected pouch.

A substantially flat pouch 110 is formed and sewn to back fabric sheet 22 at a back surface 112 of the gun case 10. Pouch 110 extends the length of case 10 and is open at one or both ends 112 and 114. An elongate weight 116 is inserted into pouch 110 to insure proper hanging of the gun case, as will be further explained. More than one weight 116 may be inserted in pouch 110 and the weights may be of different lengths. With guns removed and weights removed, the gun case 10 may be readily folded or rolled up for storage.

Another substantially flat pouch 120 may be formed and sewn to the back fabric sheet 22 of the pouch. The ends 122 and 124 of pouch 120 are open to allow insertion of such items as may be placed therein.

Pockets 130 may also be formed between portions of the fabric sheets 20 and 22, and zippers 132 may be provided to allow access to the pockets through openings in the fabric backing sheet 20. The pockets 130 accommodate ammunition, maps and other chosen items.

Conventional quick couplers are preferably used to suspend the case 10 from the gunwale 140 of a boat, shown fragmentarily at 142. The quick couplers include female members 144 on the ends of short strips 146 that are spaced along and attached by screws 148, or the like to the gunwale of the boat. Corresponding male coupling members 150 on short straps 152 are secured to the garment holes 60 of the gun case by rivets 54, or the like.

Although a preferred embodiment of my invention has been herein described, it is to be understood that the present disclosure is by way of example and that variations are possible without departing from the subject matter coming within the scope of the following claims, which subject matter I regard as my invention.

I claim:

1. A long gun case for use in boats comprising
a flexible backing composite having a top edge and a bottom edge interconnecting spaced apart ends, a face and a back;
means for connecting the top edge to a gunwale of a boat; and
at least one long gun receiving pouch suspended from adjacent to said top edge, said pouch being elongate and open ended.

2. A long gun case as in claim 1, wherein the long gun receiving pouch includes
means for holding a portion of each of said ends spread open to permit insertion of the muzzle of a gun therein.

3. A long gun case as in claim 1, including
at least a pair of suspended long gun receiving pouches, with one pouch suspended underneath the other top pouch and spaced to allow insertion of a gun muzzle into the ends of the pouch suspended underneath the top pouch

4. A long gun case as in claim 2, wherein
the pouch has a back and bottom formed of mesh to allow drainage from said pouch and a fabric face sheet front to obscure vision into said pouch.

5. A long gun case as in claim 4, further including
an elongate, open ended weight pouch at the bottom edge to receive weights therein.

6. A long gun case as in claim 5, further including
at least one elongate weight inserted in the weight pouch.

7. A long gun case as in claim 3, wherein
each pouch has a back and bottom formed of mesh to allow drainage from said pouch and a fabric face sheet front to obscure vision into said pouch.

8. A long gun case as in claim 7, further including
an elongate, open ended weight pouch at the bottom edge of each pouch to receive weights therein.

9. A long gun case as in claim 8, further including
at least one elongate weight inserted in each weight pouch.
